(19) United States
(12) Patent Application Publication
(10) Pub. No.: US 2026/0062124 A1
(43) Pub. Date: Mar. 5, 2026

(54) PAYLOAD DEPLOYMENT SAFETY SYSTEM FOR AVALANCHE CONTROL USING AN UNMANNED AIRCRAFT SYSTEM

(71) Applicant: Drone Amplified, Inc., Lincoln, NE (US)

(72) Inventors: Ralph T. Blumberg, Audubon, NJ (US); Carrick J. Detweiler, Lincoln, NE (US); Joseph R. Albanese, Sewell, NJ (US); Daniel M. Justa, Philadelphia, PA (US)

(21) Appl. No.: 19/306,560

(22) Filed: Aug. 21, 2025

Related U.S. Application Data
(60) Provisional application No. 63/689,230, filed on Aug. 30, 2024.

(51) Int. Cl. B64D 1/06; B64U 20/80; F42C 15/40; F42D 1/04; F42D 1/045; F42D 3/06

(52) U.S. Cl. CPC B64D 1/06; B64U 20/80; F42C 15/40; F42D 1/042; F42D 1/045; F42D 3/06; B64U 2201/20

(57) ABSTRACT

A payload deployment safety system for avalanche control utilizing an Unmanned Aircraft System (UAS) that makes use of redundant systems. The system includes a main control system and an auxiliary control system. The main control system includes dual physical communication channels, a primary dropper for holding an explosive payload, and an electronic circuit. The auxiliary control system includes an auxiliary physical communication channel, a secondary dropper, and an electronic circuit. The system has the option to arm or disarm the explosive in flight. Upon execution of a firing command, the main and auxiliary control systems coordinate to release the explosive payload safely. The main control system verifies the firing command through the dual physical communication channels before activating the primary dropper, while the auxiliary control system simultaneously activates the secondary dropper. The coordinated release of the payload ensures safe and effective avalanche control operations using the UAS.

### CROSS-REFERENCE TO RELATED APPLICATION(S)

This application claims priority to, and the benefit of, co-pending U.S. Provisional Application 63/689,230, filed Aug. 30, 2024, for all subject matter common to both applications. The disclosure of said provisional application is hereby incorporated by reference in its entirety.

### FIELD OF THE INVENTION

The present invention relates to a payload deployment safety system suitable for avalanche control. In particular, the present invention relates to a payload deployment safety system provides a safety system for an unmanned aircraft system (UAS) with the ability to drop payloads, such as explosive payloads for avalanche control efforts.

### BACKGROUND

Generally, “traditional” avalanche control technologies include howitzer artillery, remote avalanche control systems (RACS), hand-throw, via foot or helicopter, and uncrewed or unmanned aircraft systems (UAS).

However, these traditional approaches experience some shortcomings. Howitzer cannons, which have been the main solution for avalanche control across the US, are required to be returned to the US Army after a period of time. Remote avalanche control systems (RACS), although reliable, are limited to one location on the mountain and are expensive to install and maintain. Hand (thrown) discharges are dangerous and can be expensive when initiated from a helicopter. Current uncrewed and/or UAS do not possess the required simplicity of operation, redundancy, or reliability required to be successful and safe.

### SUMMARY

There is a need to create controlled avalanches across multiple locations while being operated from a safe location by users who are not experts in UAS technology. The deployment of explosives using a UAS must be completed in unfavorable weather conditions and must have redundant safety features to ensure that persons and property are not put at risk. The present invention is directed toward providing further solutions to address this need, while also possessing other desirable characteristics.

In accordance with embodiments of the present invention, a payload deployment safety system for avalanche control using a UAS is provided. The deployment safety system includes a main control system and an auxiliary control system. The main control system includes a first physical communication channel/link with a wireless receiver of the UAS configured to receive a first communication protocol from the wireless receiver; a second physical communication channel/link with the wireless receiver isolated from the first physical communication channel/link configured to receive a second communication protocol that is different from the first communication protocol; a primary dropper releasably holding an explosive payload; and an electronic circuit in electronic communication with the first physical communication channel/link, the second physical communication channel/link, and the primary dropper. The auxiliary control system includes a first auxiliary physical communication channel/link with a wireless receiver configured to receive the first communication protocol, a secondary dropper releasably coupled with the explosive payload, and an electronic circuit in electronic communication with the first auxiliary physical communication channel/link and the second dropper. When a firing command is executed: the first physical communication channel/link, the second physical communication channel/link, and the first auxiliary physical communication channel/link each receive the firing command; the electronic circuit of the auxiliary control system activates the secondary dropper to a state of release for the explosive payload; when the electronic circuit of the main control system verifies receipt of the firing command by the first physical communication channel/link and the second physical communication channel/link, the electronic circuit activates the primary dropper to a state of release for the explosive payload; and with both the primary dropper and secondary dropper in the state of release, the primary dropper and the secondary dropper release the payload.

In accordance with aspects of the present invention, the first communication protocol is an Ethernet protocol.

In accordance with aspects of the present invention, the second communication protocol is a serial bus protocol.

In accordance with aspects of the present invention, the system further includes a network switch configured to receive a command conveyed using the first communication protocol from the wireless receiver of the UAS and transmit the command using the first communication protocol separately to both the first physical communication channel/link of the main control system and the first auxiliary physical communication channel/link of the auxiliary control system.

In accordance with aspects of the present invention, the main control system further includes a main power source that includes a battery and a voltage regulator.

In accordance with aspects of the present invention, the auxiliary control system includes an auxiliary power source, including a battery and an isolated voltage regulator.

In accordance with aspects of the present invention, the main control system further comprises a loading state and associated sequence.

In accordance with aspects of the present invention, the control system further comprises a status indicator.

In accordance with aspects of the present invention, the payload deployment safety system is connected to a payload mount on the UAS.

In accordance with aspects of the present invention, the system further includes a ground control sub-system that includes a wireless transmitter and a controller in communication with the wireless transmitter. When the controller receives a firing command from a user, it utilizes the wireless transmitter to wirelessly transmit the firing command to the wireless receiver, using both the first and second communication protocols.

In accordance with aspects of the present invention, the system further includes an arm/disarm subsystem including an engagement mechanism and an arm/disarm mechanism. The engagement mechanism removably engages one or more ignitors coupled with the explosive payload. The arm/disarm mechanism includes an electrical or mechanical actuator, an engagement link coupling the actuator with the engagement mechanism, and a mount removably coupling the one or more ignitors with the UAS. When the engagement mechanism is selectively engaging one or more ignitors of the explosive payload, the explosive payload is in an armed-state, and when the engagement mechanism is not selectively engaging one or more ignitors of the explosive payload, the explosive payload is in a disarmed-state. In certain aspects, the one or more ignitors comprise pull wire lighters (PWLs). Alternatively, the one or more ignitors comprise an ignition with an electronic detonator. The electronics detonator may be similar to a typical safety fuse assembly that includes features or benefits associated with an initiation source, delayed time fuses, or ignition source for the controlled explosive. In other certain aspects, when the explosive payload is in the armed-state, the release of the explosive payload from the payload deployment safety system causes the one or more ignitors of the explosive payload to be activated as the engagement mechanism holds the one or more ignitors and the explosive payload drops from the UAS, the one or more ignitors igniting one or more fuses connected to the one or more ignitors to detonate the explosive payload. In still other further aspects, the explosive payload includes an explosive, one or more fuses in communication with the explosive, and one or more ignitors in communication with the one or more fuses. In some additional aspects, the explosive further includes a serialized identification. In other such aspects, the mount positions the one or more ignitors so as to be removably engaged by the engagement mechanism.

In accordance with aspects of the present invention, the electronic circuit is implemented using a processor.

In accordance with embodiments of the present invention, an arm/disarm system for payload deployment for avalanche control using a UAS is provided. The system includes an engagement mechanism and an arm/disarm mechanism. The engagement mechanism removably engages one or more ignitors coupled with an explosive payload. The arm/disarm mechanism includes an electrical or mechanical actuator, an engagement link coupling the actuator with the engagement mechanism, and a mount removably coupling the one or more ignitors with the UAS. When the engagement mechanism is selectively engaging one or more ignitors of the explosive payload, the explosive payload is in an armed-state and when the engagement mechanism is not selectively engaging one or more ignitors of the explosive payload, the explosive payload is in a disarmed-state.

In accordance with aspects of the present invention, the one or more ignitors involve pull wire lighters (PWLs) or electric detonators.

In accordance with aspects of the present invention, when the explosive payload is in the armed-state, release of the explosive payload causes the one or more ignitors of the explosive payload to be activated as the engagement mechanism holds the one or more ignitors and the explosive payload drops from the UAS, the one or more ignitors igniting one or more fuses connected to the one or more ignitors to detonate the explosive payload.

In accordance with aspects of the present invention, the mount positions the one or more ignitors so that they can be removably engaged by the engagement mechanism.

In accordance with aspects of the present invention, the explosive payload includes an explosive, one or more fuses in communication with the explosive, and one or more ignitors in communication with the one or more fuses. In some such aspects, the explosive further includes a serialized identification.

The payload deployment safety system of the present invention is designed from the ground up with electrical, communication, and mechanical redundancy to ensure that no single point of failure results in an unintended release of an armed explosive. Additionally, the payload deployment safety system of the present invention incorporates the ability to arm or disarm the explosive payload while in flight, ensuring that it is unlikely to explode if dropped or if the UAS crashes. This also allows the ability to safely drop a “disarmed explosive (sometimes called “safe” or “dud”) in an area that is safe for operation.

### BRIEF DESCRIPTION OF THE FIGURES

These and other characteristics of the present invention will be more fully understood by reference to the following detailed description in conjunction with the attached drawings, in which:

FIG. 1 is a system diagram showing aspects of a payload deployment safety system used for avalanche control using an Uncrewed and/or Unmanned Aircraft System (UAS) in accordance with an embodiment of the present invention;

FIG. 2 is a state diagram for the main control system of the payload deployment safety system;

FIG. 3 is a state diagram for the auxiliary control system of the payload deployment safety system;

FIG. 4 is a system wiring diagram of the main and auxiliary control systems of the payload deployment safety system;

FIG. 5 is a bottom view of the payload deployment safety system;

FIG. 6 shows the payload deployment safety system deployed on a UAS;

FIG. 7 is a system diagram of an arm/disarm subsystem;

FIG. 8 is a side view of an arm/disarm subsystem in accordance with one embodiment;

FIG. 9 is a front view of an arm/disarm subsystem in accordance with one embodiment;

FIG. 10 is a diagram of an explosive payload used with the payload deployment safety system;

FIG. 11 shows the explosive of the explosive payload; and

FIG. 12 shows an assembled explosive payload.

### DETAILED DESCRIPTION

An illustrative embodiment of the present invention relates to a payload deployment safety system for deployment of payloads, such as explosive payloads for avalanche control, utilizing an Unmanned and/or Uncrewed Aircraft System (UAS). The inventive payload deployment safety system utilizes redundant systems to enhance safety over prior solutions. The system includes a main control system and an auxiliary control system. The main control system includes dual communication channels, a primary dropper for holding an explosive payload, and an electronic circuit. The auxiliary control system includes an auxiliary physical communication channel, a secondary dropper, and an electronic circuit. Upon execution of a firing command, the main and auxiliary control systems validate that all safety conditions are met and coordinate to release the explosive payload safely. The main control system verifies the firing command through the dual physical communication channels before activating the primary dropper, while the auxiliary control system simultaneously activates the secondary dropper. The coordinated release of the payload ensures safe and effective avalanche control operations using the UAS. A remote arm/disarm subsystem is also included as an option within the inventive system to provide additional safety capabilities.

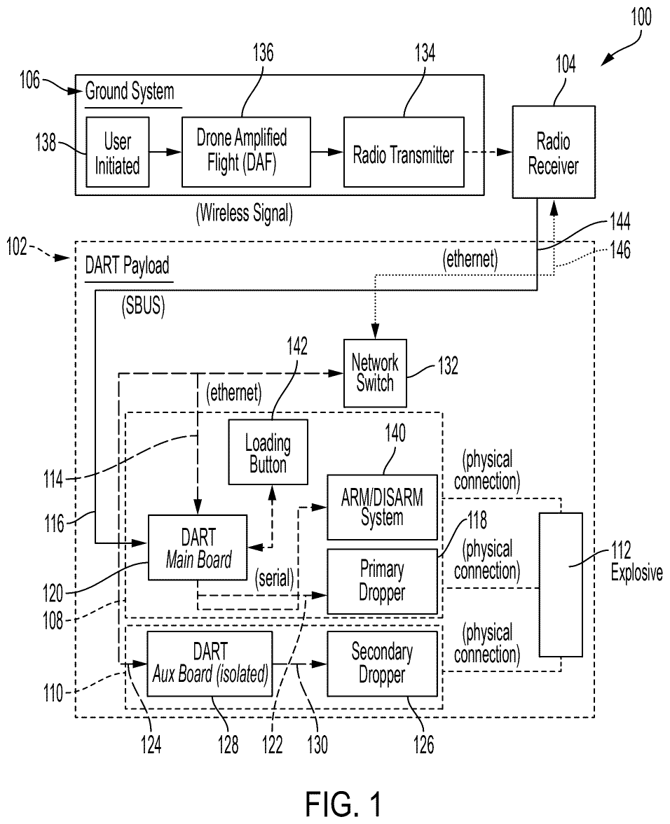

FIG. 1 through FIG. 12, wherein like parts are designated by like reference numerals throughout, illustrate an example embodiment or embodiments of a payload deployment safety system for avalanche control utilizing an Uncrewed and/or Unmanned Aircraft System (UAS), according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts a diagram of the system 100 of a payload deployment safety system 102 used for avalanche control using an Uncrewed and/or Unmanned Aircraft System (UAS) 150 in accordance with an embodiment of the present invention. Here, the system 100 includes the payload deployment safety system 102, a wireless receiver 104 of the UAS, and a ground control sub-system 106.

The payload deployment safety system 102 comprises a main control system 108 and an auxiliary control system 110, which control the deployment of an explosive payload 112. The main control system 108 comprises a first physical communication channel/link 114, a second physical communication channel/link 116, a primary dropper 118, and an electronic circuit 120. The auxiliary control system 110 comprises a first auxiliary physical communication channel/link 124, a secondary dropper 126, and an electronic circuit 128.

The first physical communication channel/link 114 is with the wireless receiver 104 of the UAS 150 and is configured to receive a first communication protocol from the wireless receiver 104. In certain embodiments, the first communication protocol is an Ethernet protocol. Accordingly, the first physical communication channel/link 114 can comprise any suitable physical electronic communication connection capable of transmitting an Ethernet protocol, such as an Ethernet port, as would be appreciated by those of skill in the art.

The second physical communication channel/link 116 is also connected to the wireless receiver 104 and is isolated from the first physical communication channel/link 114. The second physical communication channel/link 116 is configured to receive a second communication protocol that is different from the first communication protocol. In certain embodiments, the second communication protocol is a serial bus protocol. In other embodiments, the second communication protocol is Universal Asynchronous Receiver/Transmitter protocol (UART) or serial communication. Accordingly, the second physical communication channel/link 116 can comprise any suitable physical electronic communication connection capable of transmitting data, such as a serial port, as would be appreciated by those of skill in the art.

The primary dropper 118 releasably holds an explosive payload 112. The primary dropper 118 can be any type of mechanism that is capable of releasably securing the explosive payload 112 and can be controlled by an electronic signal 122 received from the electronic circuit 120. In certain embodiments, the primary dropper 118 includes one or more servos and/or interlocks and/or switches controlled by an electronic signal 122, such as a serial interface signal.

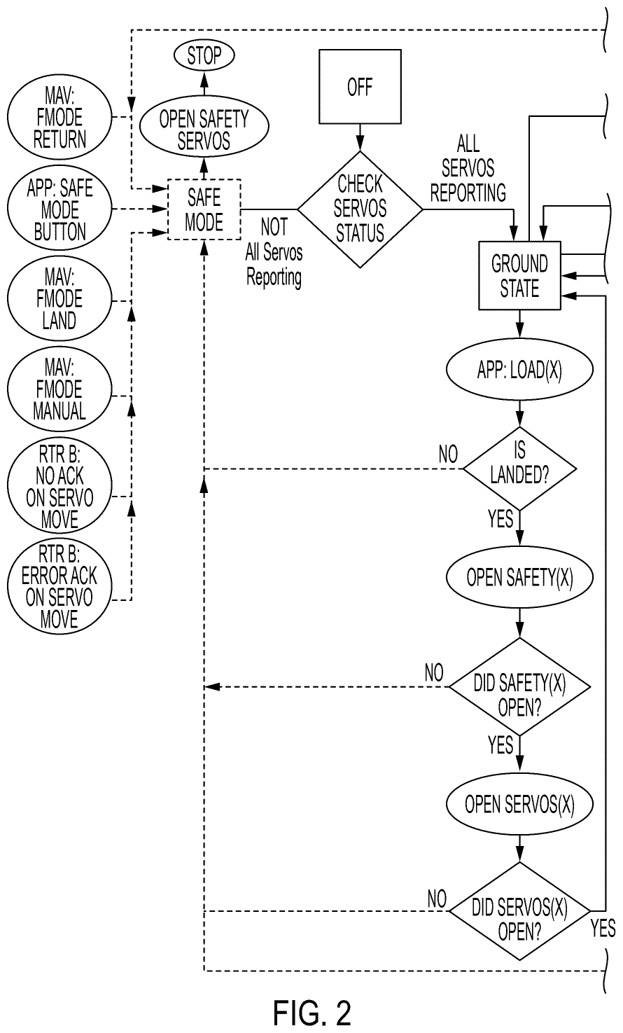

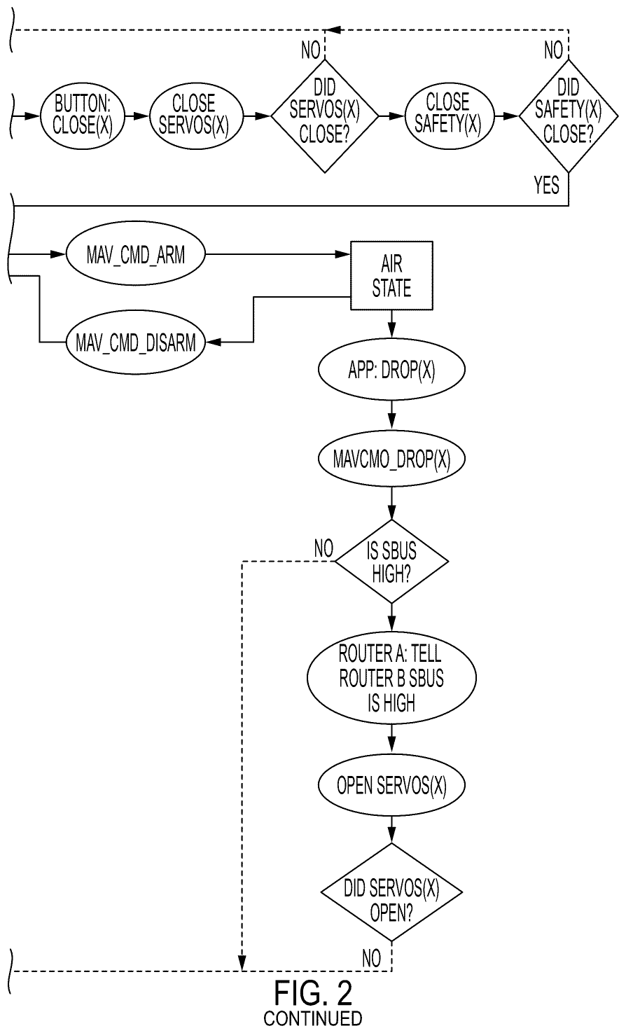

The electronic circuit 120 of the main control system 108 is in electronic communication with the first physical communication channel/link 114, the second physical communication channel/link 116, and the primary dropper 118. The electronic circuit 20 is configured to monitor and/or control the status of the UAS 150, the first physical communication channel/link 114, the second physical communication channel/link 116, primary dropper 118, and, in some embodiments, an arm/disarm subsystem 140. An illustrative example of the logic implemented by the electronic circuit 120 can be seen in FIG. 2. In certain embodiments, the electronic circuit 120 can be implemented using one or more processors. Those of skill in the art will appreciate that different electronic circuit configurations are possible, such that the present invention is not limited to the specific configurations described herein.

The first auxiliary physical communication channel/link 124 is configured to communicate with the wireless receiver 104 and is set to receive the first communication protocol. In certain embodiments, the first communication protocol is an Ethernet protocol. Accordingly, the first auxiliary physical communication channel/link 124 can comprise any suitable physical electronic communication connection capable of transmitting an Ethernet protocol, including but not limited to an Ethernet port.

The secondary dropper 126 releasably holds an explosive payload 112. The secondary dropper 126 can be any type of mechanism that is capable of releasably securing the explosive payload 112 and can be controlled by an electronic signal 130 received from the electronic circuit 128. In certain embodiments, the secondary dropper 126 includes one or more servos and/or interlocks controlled and/or switches by an electronic signal 130, such as a serial interface signal.

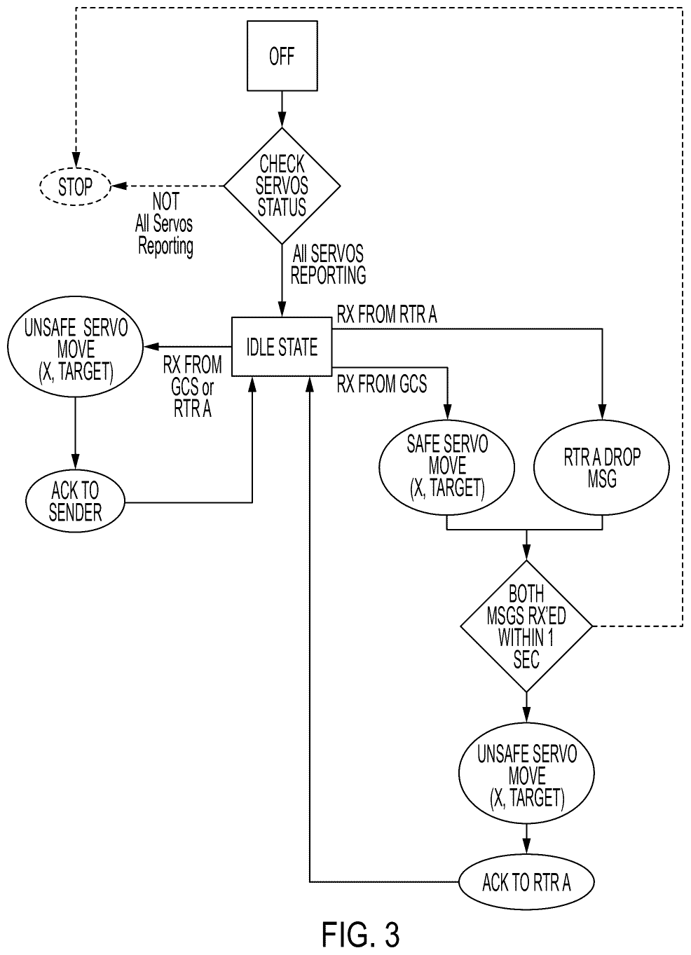

The electronic circuit 128 of the auxiliary control system 110 is in electronic communication with the first auxiliary physical communication channel/link 124 and the secondary dropper 126. The electronic circuit 128 is configured to monitor and/or control the status of the first auxiliary physical communication channel/link 124, the secondary dropper 126, and, in some embodiments, an arm/disarm subsystem 140. An example of the logic implemented by the electronic circuit 128 can be seen in FIG. 3. In certain embodiments, the electronic circuit 128 can be implemented using one or more processors.

In certain embodiments, the payload deployment safety system 102 may further include a network switch 132. The network switch 132 is configured to receive a command conveyed using the first communication protocol from the wireless receiver 104 of the UAS 150 and transmit the command using the first communication protocol separately to both the first physical communication channel/link 114 of the main control system 108 and the first auxiliary physical communication channel/link 124 of the auxiliary control system 110.

The wireless receiver 104 is a radio or other type of wireless receiver or transceiver provided as part of the UAS 150, which is used to receive and transmit data, including commands and information, between the UAS 150 and the ground control subsystem, as would be appreciated by those of skill in the art.

The ground control subsystem 106 comprises a wireless transmitter 134 and a controller 136, which are in communication with each other. The ground control sub-system 106 is configured to allow a user to operate the UAS 150. The wireless transmitter 134 can be a radio or other type of wireless transmitter or transceiver configured to communicate with the wireless receiver 104 of the UAS 150, as would be appreciated by those of skill in the art. The controller 136 can be an electronic circuit configured to receive input from a user or operator and provide corresponding commands to the UAS 150. For example, when the controller 136 receives the firing command 138 from a user, the controller 136 utilizes the wireless transmitter 134 and wirelessly transmits the firing command to the wireless receiver 104 of the UAS 150 in the first communication protocol and the second communication protocol. Similarly, the controller can also receive data from the UAS 150 and convey it to the user.

The ground control sub-system 106 transmits command information via two different protocols over the wireless transmitter. The wireless receiver 104 of the UAS 150 receives both the first protocol signal and the second protocol signal and transmits them separately on isolated channels 144, 146 to the payload deployment safety system 102 to be provided to the main control system 108 and the auxiliary control system 110. In certain embodiments, the first protocol is an Ethernet protocol, and the second protocol is a serial bus protocol. The use of multiple protocols ensures that errors or other encoding issues are less likely to cause unsafe situations. In certain embodiments, the Ethernet communication of the first communication protocol is routed through the network switch 132, which electrically isolates the communication from the main control system 108 and the auxiliary control system 110. The serial bus interface (SBUS) of the second protocol goes only to the main control system 108 to avoid making an electrical connection between the two control systems 108, 110.

The payload deployment safety system 102 is designed such that when a firing command is executed, each of the first physical communication channel/link 114, the second physical communication channel/link 116, and the first auxiliary physical communication channel/link 124 receives the firing command. The electronic circuit 128 of the auxiliary control system 110 then activates the secondary dropper 126 to a state of release for the explosive payload 112. When the electronic circuit 120 of the main control system 108 verifies receipt of the firing command by the first physical communication channel/link 114 and the second physical communication channel/link 116, the electronic circuit 120 activates the primary dropper 118 to a state of release for the explosive payload 112. With both the primary dropper 118 and the secondary dropper 126 in the state of release, the primary dropper 118 and the secondary dropper 126 release the payload 112.

To drop an explosive payload 112, both the primary dropper 118 and the secondary dropper 126 must release. This requires control signals from both the first protocol (Ethernet) and the second protocol (SBUS) signals to be properly decoded by the control systems 108, 110.

In certain embodiments, the payload deployment safety system 102 can be further provided with an arm/disarm subsystem 140 that can be used to “arm” the explosive payload 112 or “disarm” the explosive payload 112 for a dud drop or in case of a systems failure through a command to the main control system 108. This design can also be extended such that the auxiliary control system 110 can also “arm” or “disarm” the explosive payload 112.

In some embodiments, the main control system 108 further comprises a load button 142 allowing a user to indicate to the payload deployment safety system 102 that an explosive payload 112 has been loaded and secured in the primary dropper 118 and secondary dropper 126. In some such embodiments, the main control system 108 comprises a status indicator, such as indicator lights, indicating the load status of the explosive payload 112.

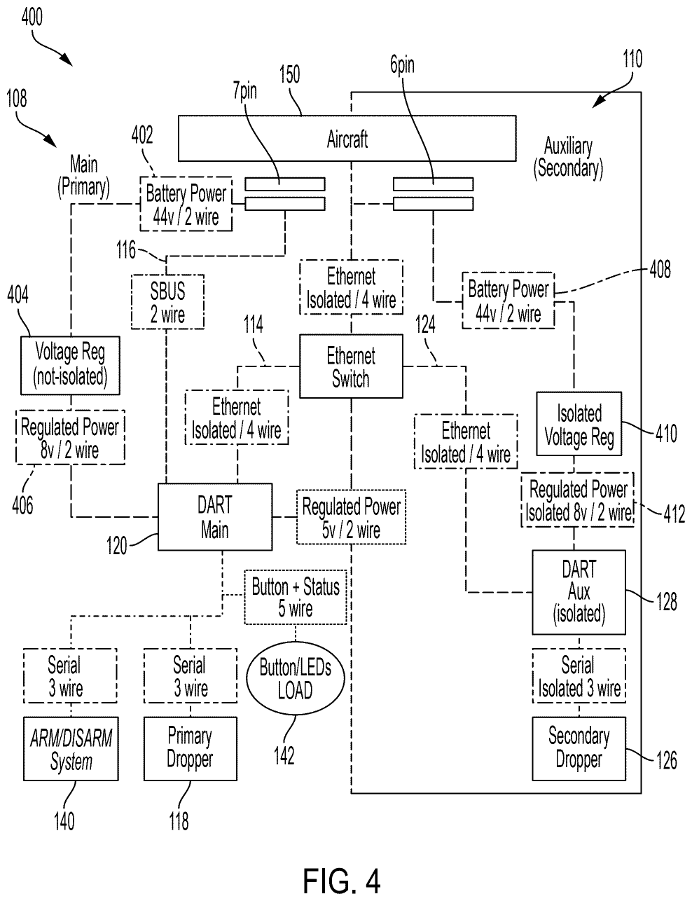

FIG. 4 is a simplified system wiring diagram 400 that further illustrates the isolation between the main control system 108 and the auxiliary control system 110 of the payload deployment safety system 102. This illustrates the power systems, in addition to the communication systems, where electrical isolation is achieved through the use of an isolated voltage regulator. Again, those of skill in the art will appreciate that other configurations are possible.

Here, the main control system 108 further comprises a main power source comprising a battery 402 and a voltage regulator 404 that provide regulated power 406 to the electronic circuit 120 of the main control system 108 and the network switch 132, which in turn powers the first physical communication channel/link 114 and the first auxiliary physical communication channel/link 124. The battery 402 also supplies power for the firing command in the second protocol over the second physical communication channel/link 116 from the UAS 150 to the main control system 108.

The auxiliary control system 110 comprises an auxiliary power source comprising a battery 408 and an isolated voltage regulator 410 that provides regulated power 412 to the electronic circuit 128 of the auxiliary control system 110 The battery 408 also provides power for supplying the firing command in the first protocol to the network switch 132.

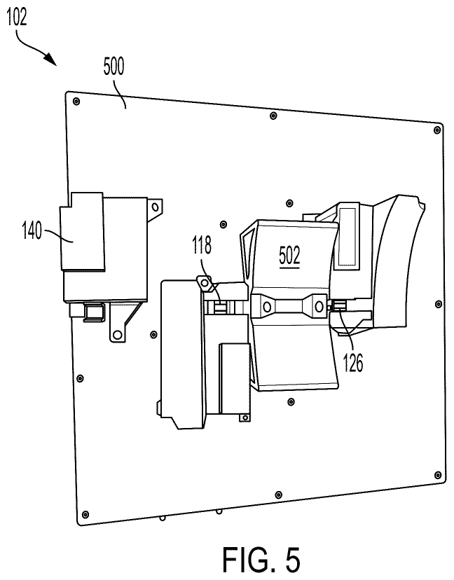

FIG. 5 shows the payload deployment safety system 102 as viewed from the bottom. Here, a platform 500 housing or otherwise containing the main control system 108 and auxiliary control system 110 is provided with a cradle 502 to hold the explosive payload 112, with the primary dropper 118 and secondary dropper 126 positioned to secure the explosive payload 112 in the cradle releasably. The arm/disarm subsystem 140 is positioned to selectively “arm” or “disarm” the explosive payload 112 secured in the cradle.

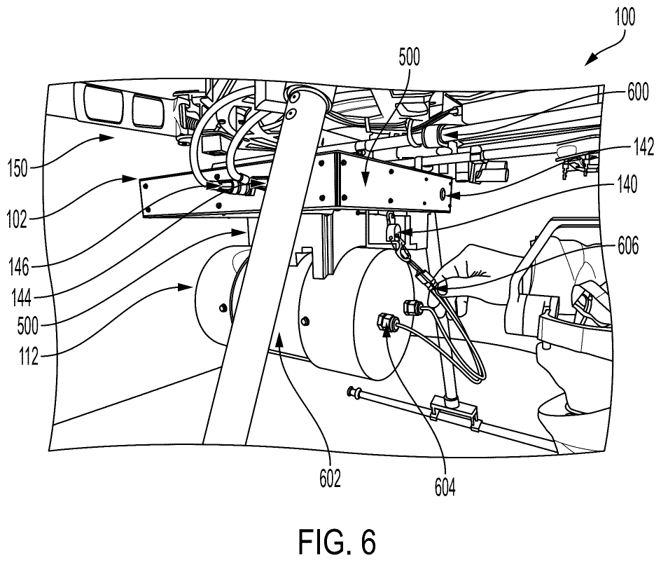

FIG. 6 shows the overall system 100 with the payload deployment safety system 102 deployed on a UAS 150 and an explosive payload 112 secured thereon. Here, the platform 500 of the payload deployment safety system 102 is connected to a payload mount 600 on the UAS 150. The first protocol signal and the second protocol signal are transmitted separately from the UAS 150 to the payload deployment safety system 102 on isolated channels 144 and 146. The explosive payload 112 is secured in the cradle 502 by the primary dropper 118 and secondary dropper 126. The explosive payload 112 comprises an explosive 602, one or more fuses 604 in communication with the explosive 602, and one or more ignitors 606 in communication with the one or more fuses 604. The one or more ignitors 606 are removably engaged by the arm/disarm subsystem 140.

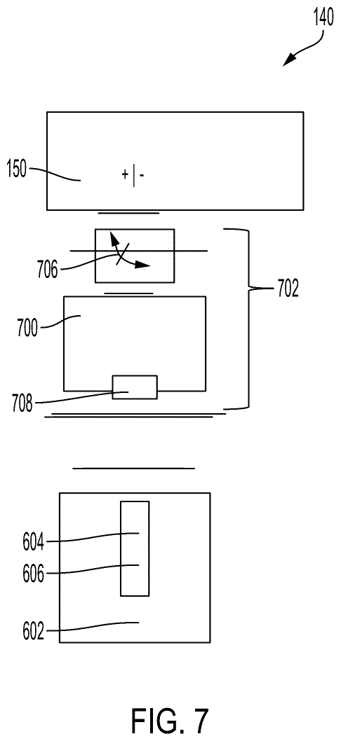

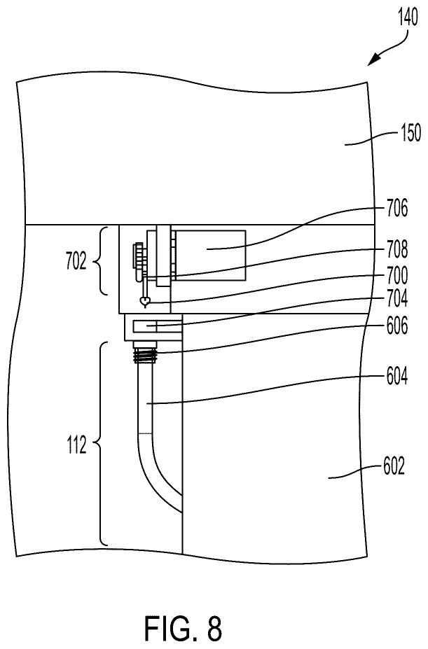

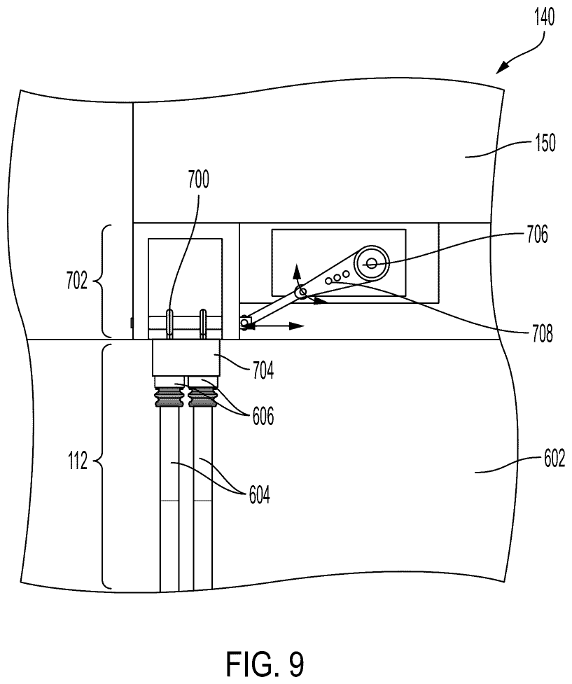

FIG. 7 depicts a system diagram of the arm/disarm subsystem 140, while FIG. 8 and FIG. 9 depict a side view and front view, respectively, of the arm/disarm subsystem 140 in accordance with one embodiment using pull wire ignitors. The arm/disarm subsystem 140 comprises an engagement mechanism 700, an arm/disarm mechanism 702, and, in the embodiments of FIG. 8 and FIG. 9, a mount 704.

The engagement mechanism 700 removably engages one or more ignitors 606 coupled with the explosive payload 112. In certain embodiments, such as FIG. 8 and FIG. 9, the one or more ignitors 606 comprise pull wire lighters (PWLs) or wires having a loop. The engagement mechanism 700 may comprise a pin or other configuration for selectively engaging or securing the one or more ignitors 606. Other forms of ignitors that are operable with the other aspects of the present inventive system can be utilized, as would be appreciated by those of skill in the art, such that the present invention is not limited to using PWLs. In some such embodiments, electronic detonators can be used as the one or more ignitors 606. The electronics detonators may be similar to a typical safety fuse assembly that includes features or benefits associated with an initiation source, delayed time fuses, or ignition source for the controlled explosive. In such embodiments, electronic detonators can be used as an alternative to the one or more ignitors 606, fuses 604, and detonators 800. Such electronic detonators are known to those of skill in the art, and therefore no additional details on their basic structure and operation are required here.

In certain embodiments, the arm/disarm mechanism 702 comprises an electrical or mechanical actuator 706, such as a motor, and an engagement link 708 coupling the actuator 706 with the engagement mechanism 700. Activating the electrical or mechanical actuator 706 moves or otherwise facilitates the engagement link 708, which in turn moves or enables the engagement mechanism 700, to selectively engage or disengage the one or more ignitors 606.

The mount 704 removably couples the one or more ignitors with the UAS 150. In certain embodiments, the mount 704 positions the one or more ignitors to be removably engaged by the engagement mechanism 700.

In operation, when the engagement mechanism 700 is selectively engaging one or more ignitors 606 of the explosive payload 112, the explosive payload is in an armed-state and when the engagement mechanism 700 is not selectively engaging one or more ignitors 606 of the explosive payload, the explosive payload is in a disarmed-state. When the explosive payload 112 is in the armed-state, the release of the explosive payload 112 from the payload deployment safety system 102 causes the one or more ignitors 606 of the explosive payload 112 to be activated as the engagement mechanism 700 holds the one or more ignitors 606 and the explosive payload 112 drops from the UAS 150, the one or more ignitors 606 igniting one or more fuses 604 connected to the one or more detonators 800 to detonate the explosive 602 of the explosive payload 112.

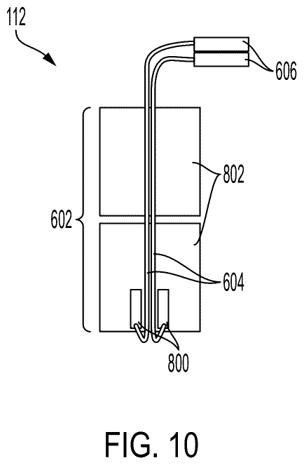

FIGS. 10-12 depict the explosive payload 112. FIG. 10 depicts the components of the explosive payload 112. The explosive payload 112 comprises an explosive 602, one or more fuses 604, and one or more ignitors 606 in communication with the one or more fuses 604. In certain embodiments, the explosive payload 112 further comprises one or more detonators 800 connected to the one or more fuses 604, which are positioned opposite the one or more ignitors 606.

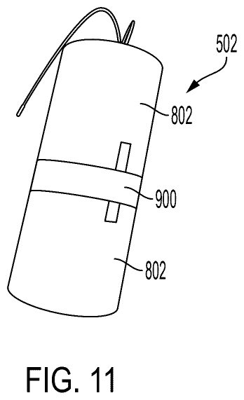

In certain embodiments, the explosive 602 comprises two #5 boosters 802 coupled together. An example of this can be seen in FIG. 11. Here, two #5 boosters 802 have been coupled together with tape 900 to form the explosive 602.

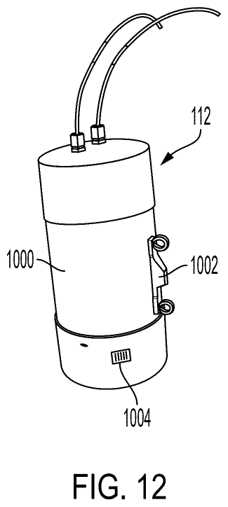

In FIG. 12, an outer housing 1000 has been placed over the explosive 602 to form the explosive payload 112. Here, an attachment mechanism 1002 has been added to the outer housing 1000 to allow the primary dropper 118 and secondary dropper 126. In certain embodiments, the explosive payload 112 further comprises a serialized identification 1004. Here is placed on the outer housing 1000. The serialized identification 1004 allows the explosive payload 112 to be logged or otherwise tracked.

The payload deployment safety system 102 presented herein provides several advantages and novel features, including: 1) the redundant electrical and mechanical design; 2) the use of two distinct communication protocols to add additional safety and redundancy; 3) the ability to Safe/Disarm the system while in flight. These factors combine to greatly enhance the system's safety.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may exist in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extent or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may, in some instances, depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way that enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A payload deployment safety system for avalanche control using an Unmanned Aircraft System (UAS), the deployment safety system comprising:
a main control system, comprising:
a first physical communication channel/link with a wireless receiver of the Unmanned Aircraft System (UAS) configured to receive a first communication protocol from the wireless receiver;
a second physical communication channel/link with the wireless receiver isolated from the first physical communication channel/link configured to receive a second communication protocol that is different from the first communication protocol;
a primary dropper releasably holding an explosive payload; and
an electronic circuit in electronic communication with the first physical communication channel/link, the second physical communication channel/link, and the primary dropper; and
an auxiliary control system, comprising:
a first auxiliary physical communication channel/link with the wireless receiver of the Unmanned Aircraft System (UAS) configured to receive the first communication protocol;
a secondary dropper releasably coupled with the explosive payload; and
an electronic circuit in electronic communication with the first auxiliary physical communication channel/link and the second dropper;
wherein when a firing command is executed:
the first physical communication channel/link, the second physical communication channel/link, and the first auxiliary physical communication channel/link each receive the firing command;
the electronic circuit of the auxiliary control system activates the secondary dropper to a state of release for the explosive payload;
when the electronic circuit of the main control system verifies receipt of the firing command by the first physical communication channel/link and the second physical communication channel/link, the electronic circuit activates the primary dropper to a state of release for the explosive payload; and
with both the primary dropper and secondary dropper in the state of release, the primary dropper and the secondary dropper release the payload.

2. The system of claim 1, wherein the first communication protocol is an Ethernet protocol.

3. The system of claim 1, wherein the second communication protocol is a serial bus protocol.

4. The system of claim 1, wherein the second communication protocol is a Universal Asynchronous Receiver/Transmitter protocol (UART).

5. The system of claim 1, further comprising:
a network switch configured to receive a command conveyed using the first communication protocol from the wireless receiver of the Unmanned Aircraft System (UAS) and transmit the command using the first communication protocol separately to both the first physical communication channel/link of the main control system and the first auxiliary physical communication channel/link of the auxiliary control system.

6. The system of claim 1, wherein the main control system further comprises a main power source comprising:
a battery; and
a voltage regulator.

7. The system of claim 1, wherein the auxiliary control system comprises an auxiliary power source comprising:
a battery; and
an isolated voltage regulator.

8. The system of claim 1, wherein the main control system further comprises a loading state and associated sequence.

9. The system of claim 1, wherein the control system further comprises a status indicator.

10. The system of claim 1, wherein the payload deployment safety system is connected to a payload mount on the Unmanned Aircraft System (UAS).

11. The system of claim 1, further comprising a ground control sub-system, comprising:
a wireless transmitter; and
a controller in communication with the wireless transmitter;
wherein when the controller receives the firing command from a user, the controller utilizes the wireless transmitter and wirelessly transmits the firing command to the wireless receiver in the first communication protocol and the second communication protocol.

12. The system of claim 1, further comprising an arm/disarm subsystem comprising:
an engagement mechanism removably engaging one or more ignitors coupled with the explosive payload;
an arm/disarm mechanism, comprising:
an electrical or mechanical actuator;
an engagement link coupling the actuator with the engagement mechanism; and
a mount removably coupling the one or more ignitors with the UAS;
wherein, when the engagement mechanism is selectively engaging one or more ignitors of the explosive payload, the explosive payload is in an armed-state; and
wherein, when the engagement mechanism is not selectively engaging one or more ignitors of the explosive payload, the explosive payload is in a disarmed-state.

13. The system of claim 12, wherein the one or more ignitors comprise pull wire lighters (PWLs).

14. The system of claim 12, wherein the one or more ignitors comprise electronic detonators.

15. The system of claim 12, wherein when the explosive payload is in the armed-state, the release of the explosive payload from the payload deployment safety system causes the one or more ignitors of the explosive payload to be activated as the engagement mechanism holds the one or more ignitors and the explosive payload drops from the UAS, the one or more ignitors igniting one or more fuses connected to the one or more ignitors to detonate the explosive payload.

16. The system of claim 12, wherein the explosive payload comprises:
an explosive;
one or more fuses in communication with the explosive; and
one or more ignitors in communication with the one or more fuses.

17. The system of claim 16, wherein the explosive further comprises a serialized identification.

18. The system of claim 12, wherein the mount positions the one or more ignitors so as to be removably engaged by the engagement mechanism.

19. The system of claim 1, wherein the electronic circuit comprises a processor.

20. An arm/disarm system for payload deployment for avalanche control using an Unmanned Aircraft System (UAS), the system comprising:
an engagement mechanism removably engaging one or more ignitors coupled with an explosive payload;
an arm/disarm mechanism, comprising:
an electrical or mechanical actuator;
an engagement link coupling the actuator with the engagement mechanism; and
a mount removably coupling the one or more ignitors with the UAS;
wherein, when the engagement mechanism is selectively engaging one or more ignitors of the explosive payload, the explosive payload is in an armed-state; and
wherein, when the engagement mechanism the is not selectively engaging one or more pull wire lighters of the explosive payload, the explosive payload is in a disarmed-state.

21. The system of claim 20, wherein the one or more ignitors comprise pull wire lighters (PWLs).

22. The system of claim 20, wherein the one or more ignitors comprise electronic detonators.

23. The system of claim 20, wherein when the explosive payload is in the armed-state, release of the explosive payload causes the one or more ignitors of the explosive payload to be activated as the engagement mechanism holds the one or more ignitors and the explosive payload drops from the UAS, the one or more ignitors igniting one or more fuses connected to the one or more ignitors to detonate the explosive payload.

24. The system of claim 20, wherein the mount positions the one or more ignitors so that they can be removably engaged by the engagement mechanism.

25. The system of claim 20, wherein the explosive payload comprises:
an explosive;
one or more fuses in communication with the explosive; and
one or more ignitors in communication with the one or more fuses.

26. The system of claim 20, wherein the explosive further comprises a serialized identification.
